(19) United States
(12) Patent Application Publication
(10) Pub. No.: US 2006/0053120 A1
(43) Pub. Date: Mar. 9, 2006

(54) Web service registry and method of operation

(75) Inventors: Wilson Kwok Fung Shum, Kowloon (HK); Patrick C.K. Wu, New Territories (HK)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Hong Kong Applied Science and Technology Research Institute Co., Ltd., New Territories (HK)

(21) Appl. No.: 10/935,977

(22) Filed: Sep. 7, 2004

(51) Int. Cl. G06F 17/30

(52) U.S. Cl. 707/100; 707/204

(57) ABSTRACT

Some representative embodiments are directed to a registry for the integration of web services. The registry may contain domain documents or data structures that model an industry or business field. The domain documents may define a respective industry in terms of multiple business types or classes. Each business type or class may be defined by classification definitions and web services definitions. The web service definitions refer to the web services that a business entity registered as belonging to the business type may or must provided. Additionally, some representative embodiments utilize the registry to dynamically select web services during execution of a business process.

### BACKGROUND

A number of protocols and standards have been proposed to facilitate business processes via the Internet. The Universal Description, Discovery, and Integration (UDDI) specifications define mechanisms to publish and discover information about “web services” using an extensible markup language (XML) files. The term web service describes business functionality exposed by a company to enable other companies, individuals, or software programs to access the service. For example, a financial services company may enable customers to obtain stock quotes using suitably encoded transactions and application programming interface (API) calls defined according to the UDDI standards.

UDDI defines the “businessEntity” structure which includes “white pages,” “yellow pages,” and “green pages” components. The “white pages” component includes address information, contact information, and known identifiers for a respective business. The “yellow pages” component includes industrial categorization based on standard taxonomies (classifications). The “green pages” component describes services that are exposed by the business. The “businessService” and the “bindingTemplate” structures are defined for the “green pages” component. The businessService structure is a descriptive container that is used to group a series of related web services related to either a business process or category services. The bindingTemplate structure provides information required to actually invoke a service. In general, the bindingTemplate structure includes a pointer to a specification supported by the respective web service.

Another example of a web standard proposed for business processes is the Business Process Modeling Language (BPML). BPML is a meta-language that can be used to describe business processes as a specific business process modeling language layered on top of the extensible BPML XML schema. BPML represents business processes as the interleaving of control flow, data flow, and event flow. BPML is associated with a number of limitations. In particular, BPML is limited by the necessity of predefining an entire business process. Likewise, the Business Process Execution Language for Web Services (BPEL4WS) is another language proposed for invoking business services. BPEL4WS is similar to BPML in that the entire business process must be predefined.

Web Services Description Language (WSDL) is another web standard related to business processes. WSDL uses an XML format for describing network services as a set of endpoints operating on messages. WSDL is a standard of relatively limited scope. Specifically, WSDL is intended to facilitate the binding of business process transactions to a concrete network protocol and message network formats. WSDL is not intended to provide an abstract meta-model or a framework for the integration of business processes.

### SUMMARY

Representative embodiments are directed to an intelligent registry for integration of web business services. The registry enables model-driven development for the integration of services, provides the ontology for service modeling, and the vocabulary for dynamic search criteria. In one embodiment, the intelligent registry provides a flexible, extensible, and highly expressive meta-model. The meta-model is used to define domain models. A domain model is a model of a particular business segment or field. For example, a domain model of the tourism industry could be developed using the meta-model. The domain models are reusable and, after deployment, can be used in a number of different applications.

At the abstract level, a domain can be modeled in terms of business service providers, category definitions, and service definitions. In one embodiment, a “businessServiceProvider” structure is used as an abstract structure for providing metadata related to a type of business entity within a respective domain. Examples of instances of business entities for which businessServiceProvider documents could be defined within the tourism domain include airlines, hotels, restaurants, car rental agencies, and/or the like. Within the businessServiceProvider, a categoryDefinition structure describes a categorization scheme. Typically, the categoryDefinition structure may include a set of valid values or valid ranges for each corresponding category entry. The categoryDefinition structure provides a basis for searching functionality. Also, within the businessServiceProvider structure, a serviceDefinition structure may abstractly describe the web interfaces that a particular type of business entity may or must provide. The web interfaces may be defined by identifying or referring to an XML document or other published standard agreed upon by industry participants.

Building upon the foundation of the abstract model, integration of web services may be achieved by enabling a range of applications to access the meta-model and derived instances. For example, a domain modeling expert may utilize a domain modeling application to define a domain model XML document on the intelligent registry. Business entities may, then, access the domain model XML document to publish their web services through a publication application. A business process engineer may access published web services to implement a business process from start to finish using a business process design application. At run time of a business process, a business process execution engine may use the data structures and documents created by the other applications to invoke a defined business process for a user or a particular software entity. At run time, a business process may use the service definitions and registered providers of conforming services to dynamically select services according to the defined business process.

Some representative embodiments provide registration functionality that differs appreciably from known business service registration standards. For example, UDDI merely provides a general purpose business registry. The specification is intentionally flexible to accommodate different application needs. As a result, UDDI does not prevent businesses within the same industry from publishing themselves to a UDDI registry with different information. UDDI does not enforce any unified technical interfaces upon published business interfaces. Accordingly, a registering business may publish any type of proprietary standard. Additionally, UDDI has no notion of relating two businesses of the same type. For example, while businesses may be located under a same category according to UDDI registration, it cannot be deduced that each located business supports the same set of interfaces.

By introducing the meta-model according to some representative embodiments, a language is provided to define the structure of a “businessEntity” in a domain model. The domain model can be viewed as a self-contained set of specifications that can be distributed to different applications at different stages of the service integration process. A publishing application may enforce the structure as defined by the domain model. At design time, a business process engineer may define a service building block with searching criteria (an abstract service) as well as one with fixed access point information (a concrete service). Binding an actual service to an abstract service (“concretization”) may be then deferred until runtime. In short, without the notion of a domain model, runtime concretization of abstract services would not be readily realizable, nor would applications tools for efficient service creation be available.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 depicts a data structure for abstractly modeling a business type according to one representative embodiment.

FIG. 2 depicts a system for integrating web services according to one representative embodiment.

FIG. 3 depicts a flowchart associated with the integration of web services according to one representative embodiment.

FIG. 4 depicts a flowchart for execution of a business process script according to one representative embodiment.

FIG. 5 depicts a business process script according to one representative embodiment.

### DETAILED DESCRIPTION OF THE INVENTION

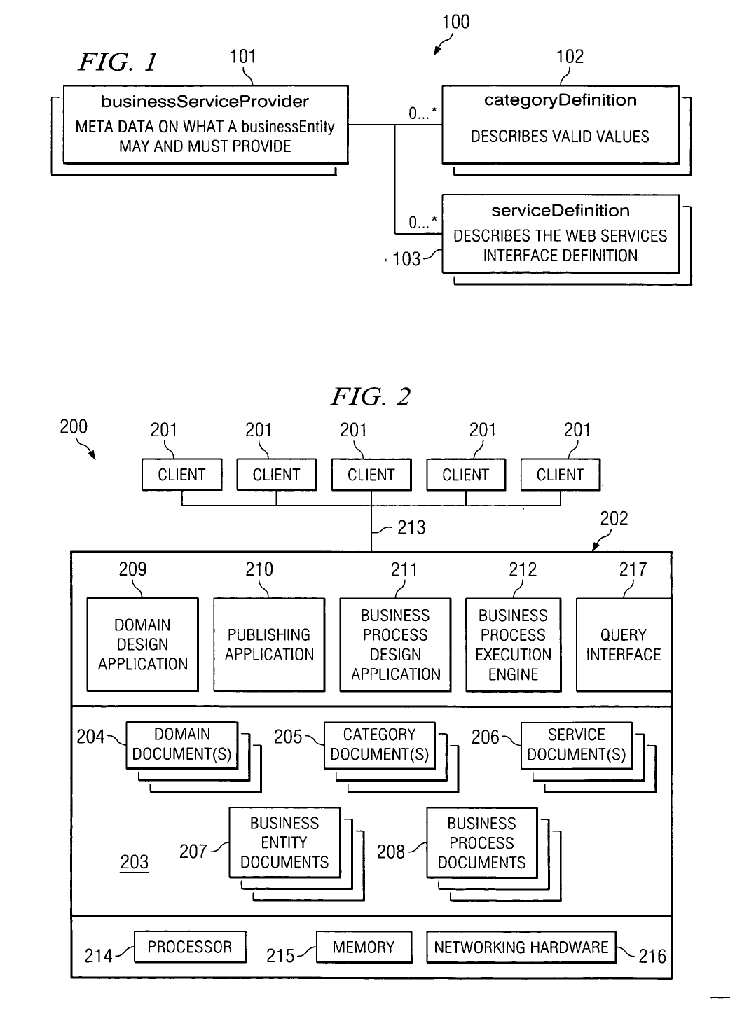

Referring now to the drawings, FIG. 1 depicts meta-model 100 according to one representative embodiment. Meta-model 100 includes businessServiceProvider structure 101. Essentially, businessServiceProvider 101 is a collection of definitions that form a unique technical signature to which a business entity should conform upon registration according to the defined business type within a respective business domain. For example, a specific implementation of businessServiceProvider structure 101 may be an airline business entity within the tourism domain. A business entity registered as an airline within the tourism domain may be required to provide an interface to detail flight arrival times, an interface to provide departure schedules, an interface for making flight reservations, and/or the like.

In some representative embodiments, businessServiceProvider structure 101 may include zero or more category definitions and service definitions. Two sub-structures, categoryDefinition structure 102 and serviceDefinition structure 103 may be used for this purpose. The categoryDefinition structure 102 may be used to implement a categorization scheme. In one embodiment, categoryDefinition structure 102 is a container for retaining a plurality of uniform resource identifiers (URIs) and locator data elements. Each URI may serve as a pointer to a technical specification that provides categorization information. It is likely that a respective specification may define more than one category type. A locator data element may be used to pinpoint the relevant part of the specification. The syntax of the locator data element may vary depending on the type of the technical specification. The serviceDefinition structure 103 describes the interface(s) that a respective business entity of the businessServiceProvider structure 101 may or must implement. In one embodiment, the serviceDefinition structure 103 is a container of one or several URIs that point to respective technical specifications describing web interfaces. For example, a URI may point to a document encoded using the web services description language (WSDL).

The implementation of businessServiceProvider structure 101, categoryDefinition structure 102, and serviceDefinition structure 103 need not be rigidly defined according to specific data structures or documents. Instead, structures 101-103 may be defined at an abstract level. By decoupling structures 101-103 from a rigid implementation, the high-level operations of an intelligent registry server can be identified without affecting the future extensibility of the model specification.

By modeling a business domain in terms of business types and the categorization definitions and the web services definitions, some representative embodiments enable functionality that is not presented by known web service standards. For example, UDDI enables registration of the web services provided by a business entity. However, the UDDI registration process is an opened-ended mechanism. Any particular business entity can register any type of web services including its own proprietary web services. The integration of web services between multiple business entities is difficult, because it is not known whether business partners will provide appropriate web services until the business partners complete the UDDI registration process. In contrast, some representative embodiments enable integration of web services without reference to the specific registration of concrete web services. Instead, the business domain model provides a basis for business process design in which services are described abstractly. Accordingly, abstract services can be selected as building blocks of a business process that calls multiple web services of multiple business partners. At the run time execution of the business process, registered business entities may be dynamically selected to perform the defined abstract services.

FIG. 2 depicts business process system 200 that supports the integration of web services according to one representative embodiment. Business process system 200 includes a plurality of clients 201 communicatively coupled to intelligent registry 202 via network 213 that enables integration of services. Intelligent registry 202 may be implemented using a suitable computer platform (having one or several processors 214, storage device(s), memory 215, networking hardware 216, etc.) and executable code or software as an example.

As shown in FIG. 2, intelligent registry 202 includes non-volatile storage 203 for storing data related to business processes. The stored data includes domain documents 204. Domain documents 204 are preferably XML documents that describe respective business segments or fields. For example, domain documents 204 may be created for the tourism industry, the consumer automotive sales industry, the consumer digital content industry, and/or the like. Domain documents 204 preferably use the abstract meta-model defined by businessServiceProvider structure 101 to define types of businesses within a business domain in terms of categorization and offered services. Intelligent registry 202 may include category documents 205 and service documents 206 that are referenced by the categoryDefinition structure 102 and serviceDefinition structure 103 of the businessServiceProvider structures 101. However, intelligent registry 202 need not store these documents. The URIs of structures 102 and 103 may alternatively or additionally reference documents stored on other servers.

Business entity documents 207 enable registration of business entities for discovery of their exposed services. Business entity documents 207 may identify the corporate identifiers of the business entities, address information, contact information, and/or the like. Also, business entity documents 207 may identify businessServiceProvider structures 101 to which the business entities conform. Within the businessServiceProvider structures 101, ranges of values or optional services may be possible. Business entity documents 207 may identify the specific value(s) associated with the categorization information. Likewise, business entity documents 207 may identify the optional services exposed by the business entities.

Additionally, it is noted that some representative embodiments do not necessarily impose rigid web service definitions upon business entity providers. For example, service providers that have non-conforming web services may use registry 202 by providing adaptation modules. The adaptation modules may perform message and other conversion functions for the proprietary or non-standard interfaces of such providers. Accordingly, the underlying non-conforming services of such providers can be employed in a transparent manner to registry 202.

Business process documents 208 define respective business processes in terms of services identified in service documents 206. Additionally, the business processes may be defined by explicitly identifying business entities that provide the services or by defining categorization criteria, and/or other suitable criteria to dynamically select the business entities at run time of the business processes.

Intelligent registry 202 includes a plurality of applications to facilitate the integration of business services. For example, intelligent registry 202 includes domain design application 209 that enables a domain expert to create a domain via software on a respective client 201. Domain design application 209 may be implement suitable graphical controls and other user display elements to provide visualization of the building blocks of a domain model, e.g., businessServiceProvider, categoryDefinition, and serverDefinition structures. The domain expert may create a document describing types of business entities within the respective industry, a categorization scheme, and services to be implemented by the types of business entities.

Additionally, technical specifications (e.g., an WSDL document) associated with either a categoryDefinition or serviceDefinition structure employ a unique identifier in the form of a URL to enable the retrieval of the document upon deployment of the domain model to registry 202. Domain design application 209 may support an automatic URL creation algorithm by deriving unique URL path bases on the namespace of the domain model and the name of the serviceDefinition and categoryDefinition. In addition, domain design application 209 may support syntax checking of the technical specifications to validate the syntactical correctness of documents included within the domain.

When a business entity decides to expose its services (“publish”), an agent of the business entity may query intelligent registry 202 using publishing application 210 to obtain information related to defined business domains and the types of businesses within those domains. A user may select a domain and one or several businessServiceProvider structures within the domain. The portion of the specifications associated with the selected structures may then be provided to the user. By providing specification information in response to user selections, downloading and management of unnecessary data may be avoided.

Furthermore, publication application 210 presents a user interface that is adapted according to the selected domain model and businessServiceProvider. The user interface may adaptively present fields for categorization values depending upon the respective businessServiceProvider. For example, the field “Hotel Star Level” would only be presented for a “Hotel” within the “Tourism” domain. Within the categorization fields, valid values or ranges of values may be provided for selection by the user. Publication application 210 may obtain other relevant information such as the name of the business, the address of the business, contact information. Furthermore, the relevant interface(s) may be identified through the user interface. For example, uniform resource locators (URLs) associated with the interfaces may be entered into respective fields. After the relevant information is obtained, publishing application 210 creates a business entity document 207 to encode the information.

Query interface 217 may be used to identify businesses that have published their web services using publication application 210. For example, queries may be communicated to query interface 217 including one or several query parameters. The query parameters may specify values or ranges of values associated with categorization information. For example, a query could be submitted to query interface 217 having a “five star” query parameter for a “Hotel” businessServiceProvider. Query interface 217 may search business entity documents 207 for entities satisfying the query parameter(s). Query interface 217 may respond to received queries by communicating documents containing matching business entities. The response from query interface 217 may be used to dynamically select a web service at run time of a business process as will be discussed below.

A business process engineer may access business process design application 211 to identify relevant service definitions to serve as building blocks of a business process. For example, a travel agency may implement a business process that uses the registered services of airlines, hotels, car rental agencies, and/or the like.

In one representative embodiment, business process design application 211 provides a graphical notation for expressing business processes. Business process design application 211 may include a visual business process modeler, service definition editor, and business process script generator. The visual business process modeler may provide graphical environment for a business process engineer to define a workflow and the order of building blocks within a business process. The service definition editor enables the business process engineer to to define whether a service selected for a business process is a concrete service (e.g., services explicitly exposed by a registered business entity) or an abstract service (e.g., services described generally without identifying a specific supporting business entity). If an abstract service is defined, the criteria to be subsequently used at run time to select concrete services corresponding to the abstract services may be applied. The business process engineer may use the business process script generator to create the business process script when the design is completed.

Business process execution engine 212 may be employed to execute a business process. Business process execution engine 212 may retrieve a respective business process document 208. Business process execution engine 212 may process information received from a user as input to the business process. The received information may be applied to query business entity documents 207 to identify suitable services using query interface 217. Likewise, the criteria defined for abstract services are used to query business entity documents to identify suitable concrete services. The access points of the services are located using the information encoded within business entity documents 207. The services are invoked and suitable information is communicated to the services. Information received from one invoked service may be supplied to a subsequently invoked service to provide a coordinated business process flow.

Although FIG. 2 depicts intelligent registry 202 using an integrated and centralized architecture, the present invention is not so limited. A distributed architecture may be employed if desired. For example, domain documents 204, category documents 205, service documents 206, business entity documents 207, and business process documents 208 could be maintained by separate servers. Likewise, applications 209-212 could be implemented on other servers that access documents 204-208 using API calls or other suitable functionality.

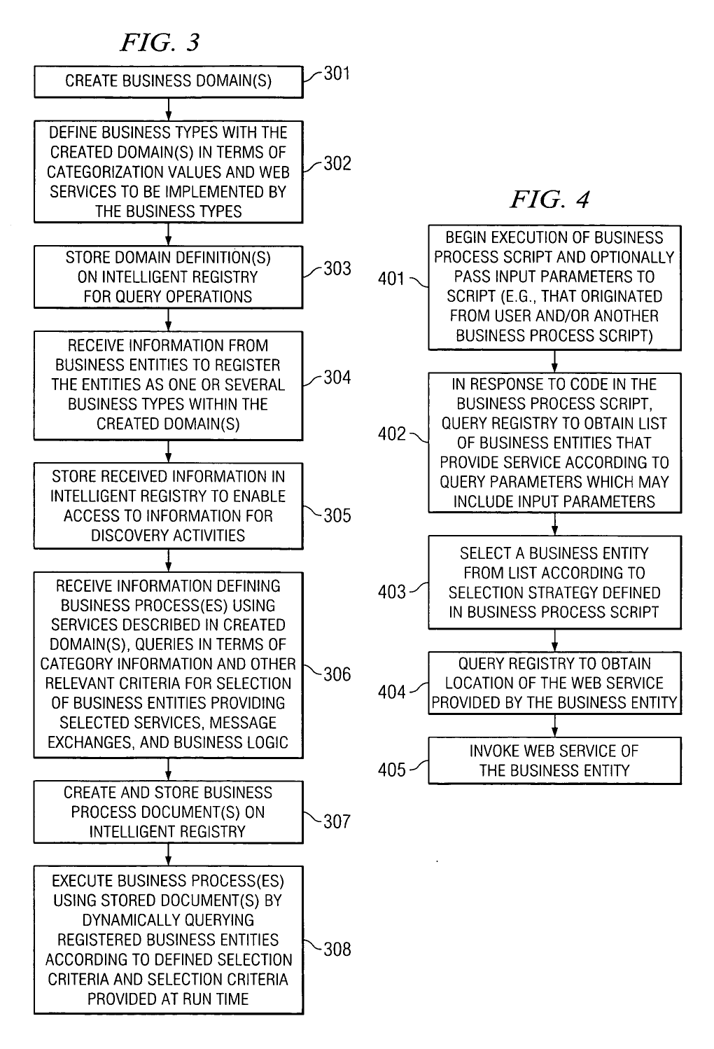

FIG. 3 depicts a flowchart for the integration of business services according to one representative embodiment. The flowchart of FIG. 3 may be implemented, in part, using software code or executable instructions retrieved from any suitable computer readable medium. In step 301, business domains are created. In step 302, business types within the created domains are defined in terms of categorization values and web services to be implemented by the business types. In step 303, the domain definition(s) may be stored on a registry platform such as intelligent registry 202 to support query operations. In step 304, information is received from business entities to register the entities as one or several business types within the created domain(s). In step 305, the received information may be stored in the intelligent registry to enable access to the information for discovery activities. In step 306, information is received to define business processes. The business processes are defined using the services described in the created domains, queries involving categorization information and other relevant criteria, message exchanges, and business logic. In step 307, business process documents are created and stored on the intelligent registry. In step 308, business processes are executed using the stored documents. Additionally, dynamic querying of the registered business entities according to defined selection criteria and selection criteria provided at run time may be used to select the business services for invocation during the execution of the business processes.

In one embodiment, an intelligent business process modeling language (iBPML) is defined to enable the description of the flow of a business process without requiring identification of concrete services upon creation and deployment of the business process. An iBMPL encoded business process describes the business process in terms of message exchanges between web services and business logic for processing the messages and/or for selecting the web services. The description of the business process in this manner enables service orchestration for complex business functions involving two or more business partners to occur.

In one embodiment, iBMPL employs the WSDL 1.1 standard and the XML Schema 1.0 standard to provide the data model used by iBMPL business processes. iBMPL may also include other data structures defined according to XML conventions to maintain a state definition of the business process and to enable business logic operations to occur during execution of a business process. iBMPL may include data structures defined according to XML conventions that enable messages to be exchanged between multiple business processes. By enabling coordination of multiple business processes, nested units of work are enabled with each unit having unique data requirements of various levels of granularity. Additionally, by using XML conventions, business processes may be described independently from the supporting platform and programming language used for the implementation of the associated web services.

The development of a business process using iBMPL enables the selection of different service providers in response to different situations or different needs. Static lookup criteria may be known at design time and can be directly encoded within an iBMPL document. However, a number of service providers may be identified at run time that satisfy the static lookup criteria. Additional criteria may be employed to enable a dynamic selection between the multiple service providers. The additional criteria may be obtained as input provided to the business process or may be created by the result of previously performed web services. The dynamic application of criteria in this manner enables a flexible execution of business processes in a manner that is context-aware to customer preferences.

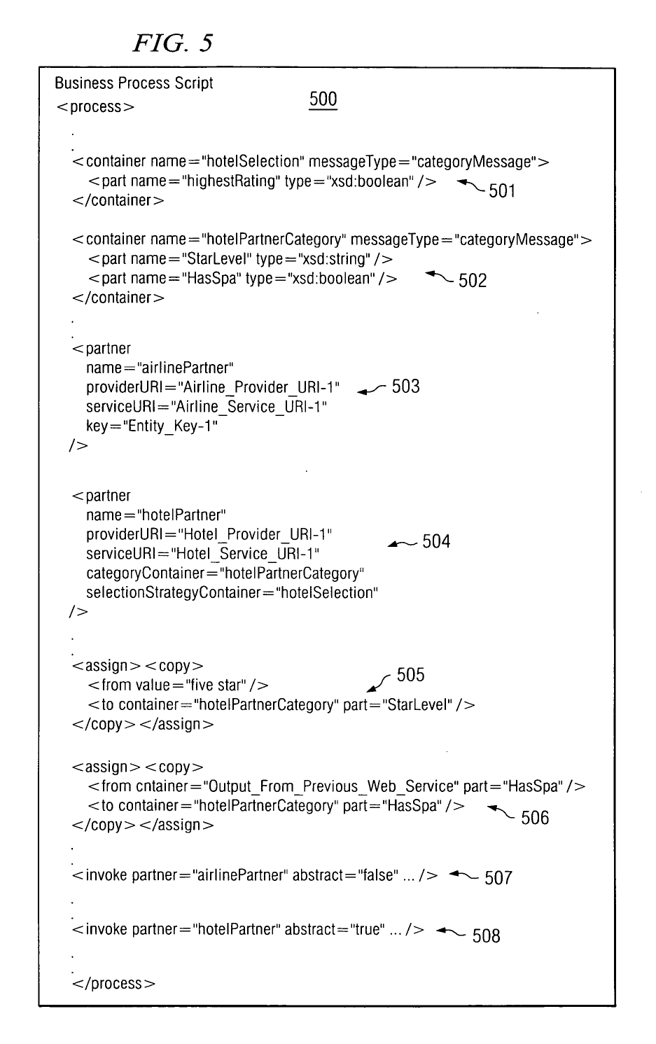

FIG. 4 depicts a flowchart for executing a business process script encoded using an iBMPL document according to one representative embodiment. The flowchart of FIG. 4 may be implemented, in part, using software code or executable instructions retrieved from any suitable computer readable medium. In step 401, the execution of the business process begins and optionally input parameters are passed to the script. The input parameters may originate from a user. For example, a graphical user interface may be provided to a user via a hyperlink markup language (HTML) form to obtain the information prior to execution of the script. Additionally or alternatively, input parameters may be obtained from the results of a previously executed script. In step 402, in response to code in the business process script, a registry is queried to obtain a list of business entities that provide a web service according to query parameters. The query parameters may be statically defined. Alternatively, the query parameters may include the input parameters. In step 403, a business entity is selected from the list according to a selection strategy defined in the business process script. In step 404, the registry may be queried to obtain the location of the web service provided by the business entity. In step 405, the web service of the business entity is invoked. Other details regarding the execution of a business process script shall be discussed with respect to FIG. 5.

For example, suppose a travel agency specializes in providing “luxury” vacation packages. The travel agency may create a business process that makes the necessary reservations through web services of third-party business entities to provide the vacation packages to customers. To provide the packages, a business process script may be created that queries intelligent registry 202 for hotels within the tourism domain that have a “five star” rating. Because the travel agency specializes in providing luxury vacations, the five star rating criterion may be static defined within the business process script. A list of multiple hotels within the user's destination may be obtained in response to the query. The business process script may define a selection strategy to apply one or several criteria to select a particular hotel from the list of hotels. After selection of the particular hotel, the business process script may call the web service of the hotel to make the appropriate reservation.

As another example, the travel agency may enable customers to pay for the vacation packages by a number of mechanisms. The user's selection may be obtained using an HTML form. The selection may be communicated to a business process script as an input parameter. Because the selection criteria is not statically defined, the input parameter defining the desired payment method may be passed to a query operation of the business process script. The business process script may then dynamically locate one or several business entity providers in response to the user selection. Selection strategy logic may be applied to select a single business entity provider. Another query may be performed to obtain the location of the web service of the selected business entity provider. The web service is then called to perform the payment service.

FIG. 5 depicts business process script 500 according to one representative embodiment. In script 500, <invoke> elements 507 and 508 are the script commands used to invoke the web services for “airlinePartner” and “hotelPartner” respectively. The detailed partner information is described by <partner> elements 503 and 504, respectively.

As previously discussed, some representative embodiments enable concrete and abstract web services to be included within a business process script. As shown in business process script 500, when a concrete service is selected, the value of the “abstract” attribute within <invoke> element 507 is set to false thereby indicating that a concrete web service is to be invoked. The value of the “key” attribute of <partner> element 503 (i.e., “Entity_Key-1”) points to the specific web service to be invoked. The value of the abstract attribute within <invoke> element 508 is set to false thereby indicating that the web service to be invoked is selected dynamically at run time. No key attribute is provided within <partner> element 504, because the web service is to be dynamically selected.

As shown in business process script 500, the basis for the abstract “hotelPartner” service invocation is referenced by the value of the “categoryContainer” attribute within <partner> element 504. The value points to <container> element 502 which stores the criteria. The business process engineer may explicitly define criteria for an abstract service. For example, business process script 500 includes the “five star” rating within <assign> element 505. The criteria could also be defined as input provided to the business process or may be created by the result of a previously preformed web service (e.g., as shown in <assign> element 506). Business process engine 212 obtains the criteria from <container> element 502 and passes the criteria to intelligent registry 202. Intelligent registry 202 responds by communicating the identification of web services corresponding to the criteria.

When multiple web services are identified by intelligent registry 202, selection strategy may be employed to select one of the web services for invocation. In business process script 500, the value of selectionStrategyContainer attribute within <partner> element 504 points to <container> element 501 which encapsulates the selection criteria. The business process engineer may explicitly define the selection criteria. Additionally or alternatively, selection criteria may be obtained from input to the business process or may be created as the result of previously performed web services. An <assign> element may be used to include the criteria within <container> element 501.

Some representative embodiments may provide a number of advantages. For example, a flexible meta-model may be used to create business domains in terms of types of business service providers. Additionally, the creation of business domains enables the publication of web services to occur in an organized manner with a minimal degree of complexity. Moreover, the creation of business domains enables the creation of business processes to occur in an efficient manner. Furthermore, some representative embodiments enable business processes to be defined abstractly using the business domain models and to dynamically bind to concrete services at run time.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
creating a business domain data structure that identifies a business field;
creating business type data structures, for said business domain data structure, that define categories of businesses within the business field;
creating categorization definitions, for business type data structures, that provide descriptive information related to categories of businesses;
creating web service definitions, for business type data structures, that identify software interfaces offered by categories of businesses and accessible via a communication network; and
providing access to said business domain data structure, business type data structures, categorization definitions, and web services definitions through a registry platform that is accessible via a communication network.

2. The method of claim 1 further comprising:
registering a business entity with said registry platform using a business type data structure to present said business entity as a business within one of said categories of businesses.

3. The method of claim 2, wherein said registering comprises:
identifying categorization values for said business entity.

4. The method of claim 2, wherein said registering comprises:
identifying a network location of one or several web services implemented by said business entity.

5. The method of claim 2 further comprising:
processing queries at said registry platform to identify registered business entities that implement a web service according to one or several query parameters.

6. The method of claim 5 wherein said processing occurs during execution of a business process script.

7. The method of claim 6 further comprising:
selecting, by a business process script, between multiple business entities identified in response to a query processed by said registry platform.

8. The method of claim 6 further comprising:
receiving input from a user for a business process script to serve as a query parameter.

9. A method of executing a business process using an executable script, comprising:
querying a registry to identify multiple business entities that provide a web service;
selecting one business entity from said multiple business entities using selection logic embedded within said executable script;
identifying a location of said web service offered by said selected business entity; and
invoking said web service of said selected business entity to at least partially perform said business process.

10. The method of claim 9 wherein said querying a registry provides query parameters to said registry derived from input information from a user.

11. The method of claim 9 wherein said querying a registry provides query parameters derived from execution of another business process executable script.

12. The method of claim 9 wherein said querying a registry provides query parameters that are statically encoded within said executable script.

13. The method of claim 9 wherein said querying a registry provides query parameters that identify one or several values associated with a classification scheme defined for a type of business entity.

14. A registry platform, comprising:
a domain structure that identifies a business field;
business type structures that define categories of businesses within the business field;
categorization definition structures that provide descriptive information related to said categories of businesses;
web service definition structures that identify interfaces offered by said categories of businesses; and
a query interface for identifying business entities registered according to said business type structures.

15. The registry platform of claim 14 further comprising:
a domain design application for creating domain structures.

16. The registry platform of claim 14 further comprising:
a publication application for receiving information to register a business entity according said business type structures.

17. The registry platform of claim 14 further comprising:
a business process design application for creating business process scripts that invoke web services of business entities registered according to said business type structures.

18. The registry platform of claim 17 further comprising:
a business process execution engine for executing said business process scripts.

19. A system for executing a business process script, comprising:
means for querying a registry to obtain a list of business entities that provide a web service in response to a script element within said business process script;
means for selecting a business entity from said list in response to at least one selection parameter within said business process script;
means for identifying a location of said web service offered by said selected business entity; and
means for invoking said web service of said selected business entity during execution of said business process script.

20. The system of claim 19 wherein said means for querying communicates a query parameter derived from input information from a user who initiated execution of said business process script.

21. The system of claim 19 wherein said business process script includes a statically defined parameter provided to said means for querying.

22. The system of claim 19 wherein said means for querying passes query parameters to said registry that identify one or several values associated with a classification scheme defined for a type of business entity.
